(19) United States
(12) Patent Application Publication
(10) Pub. No.: US 2003/0139083 A1
(43) Pub. Date: Jul. 24, 2003

(54) Installation Slot With Oblique Guide Plate

(76) Inventor: Kuo-Chin Huang, Hsinchu City (TW)

(21) Appl. No.: 10/248,399

(22) Filed: Jan. 16, 2003

(30) Foreign Application Priority Data
Jan. 18, 2002 (TW) 091200735

(51) Int. Cl. H01R 13/64

(52) U.S. Cl. 439/374

(57) ABSTRACT

### Abstract of Disclosure

The present invention is an installation slot with an oblique guide plate, whose motherboard is wrapped by a casing, which constructed by an upper metal casing and a lower metal casing. The motherboard is isolated in a closed room of the casing except for plural necessary open holes; thus a height difference is between the motherboard and the casing. Wherein an installation slot is on the casing and internally set a connector. A rim of the installation slot extends from the casing to an internal of the installation slot and downward at least an oblique guide plate, and an edge of the rim is as close as possible to reach an edge of the connector for that a few fingers being capable of clamping a plug from a motherboard module, the installation slot, the connector to a plurality of pins inside the connector, and then the pins electrically connecting to outside via several connection wires for enhancing EMI shielding effect and reducing noise.

### Background of Invention

1.Field of the Invention

This invention relates to an installation slot with a connector, and more particularly, to the installation slot with an oblique guide plate.

2.Background of the Invention

Recently, the semiconductor field being developed into another stage so as to that the products being tiny and light; hence the width of the circuit is getting narrower; further to the importance and the needs of high-frequency communication are highly increasing. On the other hand, the noise generated by the high-frequency communication may be a target problem to be figured out. However, how to prevent the high-frequency and consider the costs of mass-production and labor for simply and fast assembling products and saving production time and cost or providing customers and consumers an easy assembling method for marketing acceptance is an important issue.

Please refer to figures 1 and 2, which are a motherboard module 10 in prior art. Wherein a motherboard 11 is wrapped by two casings, which constructed by an upper metal casing 12 and a lower metal casing 13. The motherboard 11 is isolated in a closed room of the two casings except for plural necessary heat-diffusing holes 18, connection and fixing holes for enhancing EMI (Electric Magnetic Interference) effect and avoiding high-frequency signals to affect motherboard 11 and preventing noise. Due to the necessity of enhancing the effect of EMI shielding, a diameter of an installation slot 16 of a general connector is as small as that only a plug 14 being through to avoid directly motherboard 11 exposed and decrease the noise from high-frequency signals; further, there is a certain height H between the upper metal casing 12, the lower metal casing 13 and the motherboard 11, and a connector 17 on motherboard 11 is away from upper metal casing 12 and lower metal casing 13, hence, while installing the plug 14, a users fingers have to hold plug 14 for supporting plug 14 to insert into the installation slot 16, and thus the connector 17 is the target for the plug 14 inserting in for completing electrical connection. Unfortunately the diameter of the installation slot 16 is tiny, there is almost no gap to visually identify that the plug 14 is inserted into the connector 17 correctly; in general, tips of fingers slightly hold tails of the plug 14, and thus the plug 14 is moved right and left and back and forth to detect the plug 14 being on a proper position or not. It is obviously known that the installation is time-consumingt and inconvenient, and sometimes the tools, such as clamp, etc., may be used.

To figure out the aforethe shortcoming, please refer to figure 3, the prior art adopts that the diameter of installation slot 16 is suitably extended to let fingers and plug 14 be put into installation slot 16.The increased gap is specially for visual identification or finger detection to finding out a proper position quickly. The way to extend the diameter is to make the gap around plug 14 bigger so as to that the exposed area for motherboard 11 being greater as well, the possibility of the noise of high-frequency signals is relatively higher, therefore the protection effect of upper metal casing 12 and lower metal casing 13 is reduced.

### Summary of Invention

The objective of the present invention is to provide an installation slot with an oblique guide plate to let the installation slot be fast and easily installed, no matter that a connector with a large difference of height.

Another objective of the present invention is to provide an installation slot with an oblique guide plate to decrease an area of directly exposing a motherboard in the installation slot for enhancing EMI shielding effect and reducing noise.

To approach aforethe objectives, the present invention whose motherboard is wrapped by a casing, which constructed by an upper metal casing and a lower metal casing. The motherboard is isolated in a closed room of the casing except for plural necessary open holes; thus a height difference is between the motherboard and the casing. Wherein an installation slot is on the casing and internally set a connector. A rim of the installation slot extends from the casing to an internal of the installation slot and downward at least an oblique guide plate, and an edge of the rim is as close as possible to reach an edge of the connector for that a few fingers being capable of clamping a plug from a motherboard module, the installation slot, the connector to a plurality of pins inside the connector, and then the pins electrically connecting to outside via several connection wires.

### Brief Description of Drawings

Figure 1 is perspective view of a motherboard module in prior art.

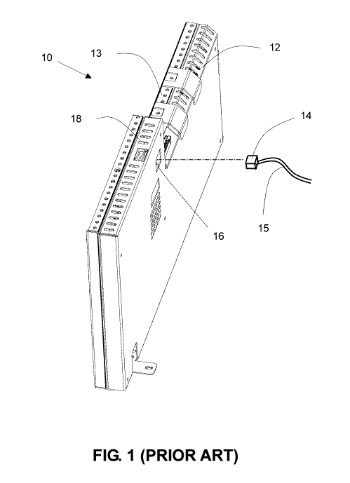

Figure 2 is a cross-sectional view of an installation slot of a connector of a motherboard in prior art.

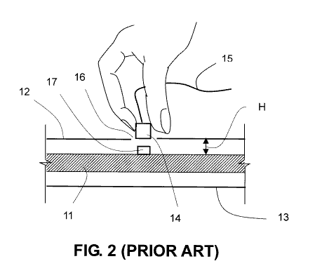

Figure 3 is a cross-sectional view of an installation slot of a connector of another motherboard in prior art.

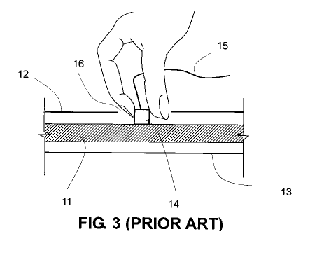

Figure 4 is an perspective view of an installation slot with an oblique guide plate of the present invention.

Figure 5 is a cross-sectional view of an installation slot of a connector of a motherboard of the present invention.

Figure 6 is a combination cross-sectional view of the installation slot of the connector of the motherboard of the present invention.

Figure 7 is a combination cross-sectional view of an installation slot of a connector of a motherboard of another preferred embodiment of the present invention.

### Detailed Description

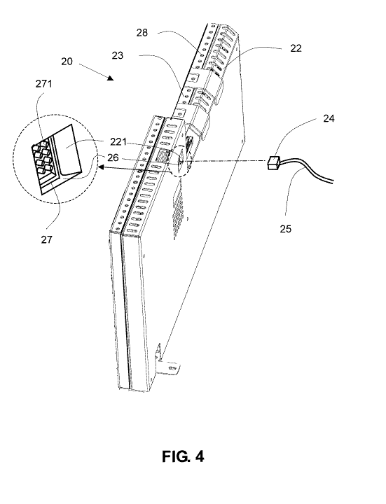

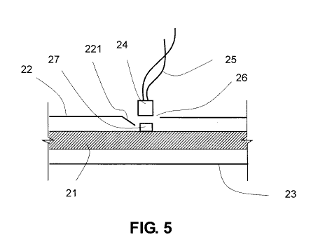

Referring to figure 4 and figure 5, which are aperspective view of an installation slot with an oblique guide plate of the present invention and a cross-sectional view of an installation slot of a connector of a motherboard of the present invention. A motherboard 21 of a motherboard module 20 is wrapped by a casing, which constructed by an upper metal casing 22 and a lower metal casing 23. The motherboard 21 is isolated in a closed room of the casing except for plural necessary heat-diffusing holes 28, connection and fixing holes for avoiding high-frequency signals to affect motherboard 21 and preventing noise.

Wherein an installation slot 26 is installed on the upper metal casing 22 of motherboard module 20 and internally set a connector 27. A rim of the installation slot 26 extends from the upper metal casing 22 to an internal of the installation slot 26 and downward at least an oblique guide plate 221, and an edge of the rim of the oblique guide plate 221 is as close as possible to reach an edge of the connector 27 for that a plug 24 being connected from the motherboard module 20, the installation slot 26, the connector 27 to a plurality of pins 271 inside the connector 27, and then the pins 271 electrically connecting to outside via several connection wires 25.

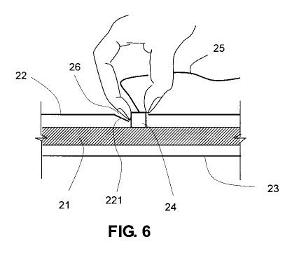

Referring to figure 6, which is a combination cross-sectional view of the installation slot of the connector of the motherboard of the present invention. While a plug 24 being connected to the connector 27, fingers clamp two sides of rear ends of plug 24 so as to that plug 24 being inserted into the installation slot 26. Via an oblique guide plate 221 of the installation slot 26 being deeply sunk into the connector 27 for users eyes being capable of seeing the connector 27 and fingers being easily closed to the connector 27, it lets the plug 24 be inserted and pressed into the connector 27; besides, due to a position of the oblique guide plate 221 not affecting or blocking the way of plug 24 inserting into the connector 27, an edge of oblique guide plate 221 is therefore very near to a side of the connector 27, and that an area for motherboard 21 exposing to outside is reduced as less as possible to prevent interference of high-frequency and noise.

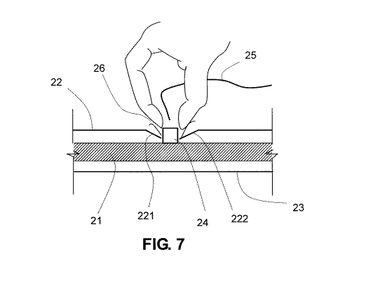

Please refer to figure 7, which is a combination cross-sectional view of an installation slot of a connector of a motherboard of another preferred embodiment of the present invention. The installation slot 26 is on the upper metal casing 22 of motherboard module 20 as well and internally set a connector 27, that is, the basic structure is similar to the first preferred embodiment. The difference is that the installation slot 26 is on two sides of a rim and extends obliquely and downward to form oblique guide plates 221 and 222 from upper metal casing 22. Edges of oblique guide plates 221 and 222 are close to two sides of connector 27 as possible as they can to shield the motherboard 21. Thus, the preferred embodiment makes that fingers, clamping two sides of plug 24, are closer to connector 27 for more rear positions of plug 24 being applied clamping force; further, while connecting plug 24 and connector 27, fingers are able to clamp plug 24 more stable to finish electrical connection.

Similarly, multiple sides of the rim of installation slot 26 are capable of extending obliquely and downward to form several oblique guide plates from upper metal casing 22 for conveniently installing plural plugs 24 from different directions. The oblique guide plates may possibly not be formed as one body with upper metal casing 22, and on the contrary, they can be independent components being obliquely inserted in the rim of installation slot 26; besides, the installation slot is able to be applied on a connection structure with a height difference of the casing.

According to aforementioned, the functions and effects of the present invention are as following:

1.Via the oblique guide plate extended obliquely and downward from the installation slot, the plug can be fixed stably and installed conveniently.

2.The edge of the oblique guide plate is near to the side of the connector as much as possible to decrease the area for directly exposing motherboard to enhance EMI shielding effect and reduce noise.

Following the detailed description of the present invention above, those skilled in the art will readily observe that numerous modifications and alterations of the device may be made while retaining the teachings of the invention. Accordingly, the above disclosure should be construed as limited only by the metes and bounds of the appended claims.

Claims

1. What is claimed is:
1.An installation slot withoblique guide plate comprising:
a casing having an internal and an external surface;
an installation slot being downward installed on the external surface to form a rim; and
at least one oblique guide plate connecting to the rim and extending obliquely to the internal of the casing.

2.The installation slot with oblique guide plate of claim 1, wherein the internal wraps a motherboard.

3.The installation slot with oblique guide plate of claim 2, wherein a connector is installed on a position of the motherboard corresponding to the installation slot, and a height difference is between the connector and the casing.

4.The installation slot with oblique guide plate of claim 3, wherein an edge of the oblique guide plate extends obliquely to a position near a side of the connector.

5.The installation slot with oblique guide plate of claim 1, wherein the oblique guide plate is an extending member of the casing.

6.The installation slot with oblique guide plate of claim 1, wherein two sides of the installation slot have oblique guide plates.

7.The installation slot with oblique guide plate of claim 1, wherein the rim of the installation slot has at least one oblique guide plate.
